(19) United States
(12) Patent Application Publication
(10) Pub. No.: US 2009/0133612 A1
(43) Pub. Date: May 28, 2009

(54) DYNAMIC MOTION SUPPRESSION OF RISER, UMBILICAL AND JUMPER LINES

(76) Inventor: Krzysztof Jan Wajnikonis, Houston, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/813,157

(22) PCT Filed: Dec. 28, 2005
(86) PCT No.: PCT/US2005/046761

§ 371 Date: Apr. 24, 2008

Related U.S. Application Data
(60) Provisional application No. 60/593,269, filed on Jan. 3, 2005.

(51) Int. Cl. F15D 1/10

(52) U.S. Cl. 114/199; 114/243

(57) ABSTRACT

Dynamic motion decoupling and damping is achieved with the use of mass, added mass, buoyancy, submerged weight and drag in arbitrary locations on catenary and/or tensioned lines. The original line configuration may or may not be modified. Novel, drag and added mass enhancing devices effective in all directions can be used to increase the suppression effectiveness and/or in order to reduce the number of devices used. This invention is suitable for use on new designs and it is also suitable for retrofitting on existing, already installed lines.

### CROSS-REFERENCE TO RELATED APPLICATIONS

This application claims the priority of U.S. Provisional Patent Application Ser. No. 60/593,269 filed Jan. 3, 2005 and entitled: “Catenary Line Dynamic Motion Suppression Arrangement” the disclosure of which is hereby incorporated by reference in its entirety.

### BACKGROUND OF THE INVENTION

1. Field of the Invention This invention relates to lines used to connect undersea equipment to related equipment on or near the surface.

2. Description of the Related Art

Petroleum exploration and production is increasingly being conducted off-shore and at ever deeper locations. Typically, a mobile offshore drilling unit (“drilling rig”) is used to create a well. Once the well is completed, a production platform or a buoy is installed at the site to recover the petroleum products which may subsequently be loaded onto a tanker or pumped via pipelines to on-shore facilities.

Exploration and production platforms take many forms. The appearance and basic features of various types of offshore platforms are obvious to anybody skilled in offshore engineering and are widely described in technical literature. Examples include ships (mostly tanker-like Floating Production Systems—FPSs and FPSOs—FPSs with off-loading), semi-submersibles (including deep draft semisubmersibles), Tension Leg Platforms (TLPs), compliant and articulated columns and towers, guyed towers, SPAR platforms, jacket (fixed) platforms and jack-up rigs.

It is noted, that many riser, umbilical, hose, cable, etc. lines that are relevant to this specification have their top ends supported for example by buoys, columns, etc. that cannot be classified as platforms.

Lines that are relevant to this specification are used in order to:
transport fluids in both directions between locations at or near the surface and at or near the bottom (examples include import and export lines transporting hydrocarbons, water and gas injection lines, gas lift lines, etc.),
transfer electrical and hydraulic power,
transfer information, including control, monitoring, data, telecommunication,
transfer loads (examples: tendons, tethers, cold tubing, etc., many risers deployed share mooring loads with ‘regular’ moorings).

Lines feature a variety of prior art configurations that are used in offshore and onshore engineering. The two major classes of lines include:
catenary lines (examples: flexible risers, Steel Catenary Risers—SCRs, umbilicals, hoses, jumpers, cables),
tensioned lines (examples: tensioned risers including freestanding and hybrid risers, and tendons or tethers).
   Most of the said lines are relevant to this specification and they are referred to herein as ‘lines’. Many line configurations are used in marine engineering, their basic features are well-known to those skilled in the art, and they are well described in technical literature.

For example Baritrop¹ depicts and describes a representative (but not complete) selection of prior art line configurations used in offshore engineering. Many of the line configurations known are referred to elsewhere in this specification. ¹Barltrop N. D. P., Floating Structures: a guide for design and analysis, Vol. 2, The Centre for Marine and Petroleum Technology, Publication 101/98, 1998.

U.S. Pat. No. 5,222,453 demonstrates the use of mass enhancing devices mounted on mooring lines and utilized to modify dynamic motions of a moored structure, without affecting static loads in the mooring system, where axial line dynamics is of primary importance. These were of little relevance to this invention that is related to different kinds of lines, and primarily, but not exclusively, to transverse line dynamics—transverse motions and bending of risers, umbilicals and hoses.

For the purpose of this specification, in most cases, the details of line description (example: flexible riser, hose or umbilical or even an SCR) is of secondary importance or even of no importance. This is because different lines are subject to the same physics, the same harsh environment and there are many similarities between equipment used with various line configurations, with lines constructed in differing ways, (including using different materials) as well as lines used for vastly differing functional purposes.

A general description and explanation follows of technical issues in offshore and onshore engineering, including problems, as relevant to this invention, as well as that of prior art in the mitigation of some of the said problems.

In particular a simple (free-hanging) catenary configuration, as well as in many implementations of other line configurations are known to experience significant movement near the seabed and interactions with the seabed and/or with structures at the seabed ends of the lines. The extent of these movements, together with the variations in the values and the sign of the effective tension and the variations in the radii of curvature of the said lines, in particular but not exclusively near the seabed, are mitigated by this invention.

Risers and mooring lines are used in many design configurations that include various applications of negatively buoyant clump weights and distributed weights, approximately neutrally buoyant lines and devices as well as positively buoyant discrete and distributed, positively buoyant elements and segments. By stating that a line is neutrally buoyant it is meant herein that the line is either neutrally buoyant or, more often, approximately neutrally buoyant. Depending on the stage of their use and on the density of the surrounding seawater or fresh water, the fact whether or not a line is positively, neutrally buoyant or negatively buoyant also depends on the density or densities of materials used, materials contained, including fluids contained inside a line or lines. Many materials used degrade and absorb water while in service, accordingly, it is a common practice to supply any buoyant devices as well as any devices desired to be approximately neutrally buoyant with some excess of positive buoyancy.

Catenary equations typically approximate well shapes of mooring lines and flexible lines like hoses, flexible pipe, cables and umbilicals. The approximation involved is due to neglecting any bending stiffness of the said line or the said line segment. In addition to these, entire SCR lines of the simple (free hanging) configurations as well as for example lazy wave SCRs are well approximated with catenary line equations in deep water, because in the said conditions bending stiffness of even a rigid metal line is negligible in comparison with the scale of the structure deployed. These include all configurations known of said flexible and said rigid lines used in offshore engineering, some of which are described by Barltrop¹.

With regard to the In-Plane (IP) shapes of the catenaries, for lines with distributed weight and buoyancy, (as it follows from the catenary equations) it is noted, that:
negatively buoyant catenary segments have their curvature ‘bulging’ downwards,
neutrally buoyant or near vertical lines are well approximated with straight lines,
and positively buoyant segments have their curvature ‘bulging’ upwards.

Discrete clump weights and buoyant connections (single clamps and buoys) IP result in local ‘sharp’ points or ‘spikes’ on catenaries, whereas:
Downward spikes occur at negatively buoyant devices;
No spikes are present at neutrally buoyant devices;
Upward spikes occur at positively buoyant devices.

Three dimensional, real catenaries have their shapes also modified in the Out-of-Plane (OOP) direction due to drag in a current. The above observations for the said IP shapes can be generalized to the shape modifications OOP in the following ways:
Relative differences in drag between segments result in more or less pronounced bulging with a uniform current, for segments generating higher or lower drag, respectively;
Localized (discrete) drag devices that generate higher drag are associated with sharper spikes.

Accordingly, in three dimensions, the combinations of the submerged weight (positive, neutral or negative) and drag forces are responsible for quasi-static shapes of catenary segments, while clump weights, tethered or clamped buoys are responsible for spikes in the shapes, because of the combinations of the weight, buoyancy and drag forces. Drag forces can significantly modify shapes of catenaries, depending on the local strength of current (i.e. current velocity) and the drag coefficient of any particular line segment or a device incorporated. Currents are seldom uniform along said lines. Typically both their velocities and directions vary along the line.

In addition to the above described, quasi-static effects of the weight, buoyancy, and current drag forces, which will be used to optimize the use of this invention on particular examples, line dynamics plays a significant part in the dynamic behavior of the said lines.

Dynamic effects on lines used in offshore engineering can be very complex. The said lines typically experience dynamic wave action that dynamically modifies the said line configurations. Typically, the wave forces act as time variable drag forces and as time variable inertia forces, approximately as described by the Morison Equation. These are modified by the interactions between waves and currents that are complex, but for practical engineering systems it is usually acceptable to approximate the interactions by superposing currents with waves kinematically. Amplitudes of wave forces decrease along lines with the water depth, which in deep water means the force decreases (approximately exponentially) to practically nil at deep water segments of the said lines. In addition to said wave forces, said lines are often subjected also to dynamic resonant excitations due to Vortex Induced Vibrations (VIVs) in currents and waves. In addition to dynamic bending of lines and to their fatigue loading, VIVs are also responsible, wherever they occur, for the increase in the quasi-static drag on the line.

It should also be stated, that many of the said lines are attached at their top ends to floating structures that also move on waves. The motions of the said structures add to the wave generated and other motions of the lines, and they are directly transferred to said lines at their top ends attached to said floating structure. All these motions are transmitted dynamically as line deformation waves along the line catenaries (straight shapes included) both up and down the catenaries with differing velocities, dependent on a nature of the wave motion generated on the line.

In particular axial waves are transmitted along said lines very fast, approximately at the speed of sound in the materials used.

Catenary tension waves are also transmitted with similar velocities along the line and they result in movements of the entire catenary, almost like a rigid body. A significant portion of the heave transferred to said line can result in motions of this kind and the deformations travel along said lines slightly slower than the acoustic waves. Other motions, together with the remaining part of the heave motion tend to be transmitted along said waves much slower as transverse deformation waves.

Static and dynamic coupling exists between the torsion of the line and its bending wherever three dimensional bending occurs (torsion waves tend to travel along said lines faster than transverse deformation waves). The latter interactions result in some redistribution of the corresponding oscillation energies, however the amplitudes resulting tend to be small in practice and in most cases these phenomena can be disregarded.

For said lines having multilayer structure, where different materials are used in different layers the wave transfer velocities tend to differ between layers, however the structurally dominant layers tend to control the motions.

All said waves traveling along said lines are subjected to reflections on the lines whenever the mass and line directions change, as well they are subject to dynamic interactions with the seabed. The quasi static and momentary dynamic shapes of catenary lines are tension controlled, and it is the property of the catenaries, that the effective tension is the lowest at and near the touch down areas to the seabed (or at ends connected to subsea structures), where the (effective) tension-controlled line stiffness is the lowest.

It is often the case that the effective tension near the touch-down becomes periodically negative, making the line susceptible to local buckling, which usually is not desirable and sometimes it is completely unacceptable (example fiber-optic lines).

All riser and pipeline engineering codes that are also relevant to umbilical lines, cables, etc. recommend effective dealing with the problem of the occurrence of negative dynamic effective tensions. These decreases in the effective tension are often accompanied with dynamic reductions in the line radii of curvature. Bird-caging of umbilical or cable lines can occur, rigid or flexible pipes usually have some built-in resilience, but complex local increases in fatigue damage typically result. Often, in presently known designs it is difficult to increase the effective tension and to increase the minimum dynamic bending radii to acceptable levels. Increasing the horizontal tension in the catenaries, which increases also the quasi-static, average effective tension at the touch-down in many known designs is known to often make the dynamic effects described above even worse.

It is noted that the said effective tension is a physical value responsible for the line shape and buckling behavior for lines that include fluid contained pipes, as described by Young and Fowler². Internal fluid pressures inside a rigid or flexible pipe, as well as pressures inside umbilical tubes, together with the external hydrostatic pressure in the surrounding water affect the actual (wall) tension in the line or lines, whereas said effective tension governs the behavior of the line. For some lines, like cables, electrical umbilicals or solid rods, effective tension and the actual tension are equal and they are simply known as tension. However, with the above understanding the term effective tension is used herein for all types of lines, whenever required, because it is more general. 2 Young R. D., Fowler J. R., Dynamic Analysis as an Aid to the Design of Marine Risers, Transactions of the ASME, Journal of Pressure Vessel Technology, Vol. 100, May 1978.

In particular, the said touch down zone line dynamics is in presently known designs both significant and troublesome for simple, free hanging catenary lines attached to floating structures. Examples of floating structures that are associated with the biggest motions are tankers (FPSs and FPSOs), particularly when they are bow or stern turret-moored. On such designs, all the risers, umbilicals, cables and mooring lines are attached to the turret, The motions of the FPSs and FPSOs are typically the biggest at their bows and sterns, which are also typical locations for turrets. However, many FPSs and FPSOs feature wide beams in order to maximize their deck areas, and accordingly line tops attached to riser banks on vessel sides can also experience high motions. Single Buoy Moorings (SBMs) and Semi-submersible vessels can also transfer considerable motions to catenary lines. Top-end induced motions are typically smaller for articulated or compliant towers, Tension Leg Platforms (TLPs), SPARS, including Truss SPARS and other deep draught vessels, but they are by no means negligible.

In the presently known designs the most effective way of mitigating the problem is to use one of the wave or ‘S’ configurations, as described by Barltrop¹.

The wave or ‘S’ configurations are sometimes unavoidable in shallow water conditions and/or with strong variable currents. Because of large horizontal motions of the vessel in these situations (that can be caused by waves, by variable currents or both), one of these configurations has to be selected in order to reduce the maximum dynamic effective and wall tensions in the catenary to an acceptable level.

In ultra deepwater conditions, the selection of for example lazy wave for a flexible, cable or an umbilical line or for SCRs can also be the best solution because of the line weight in its operational or installation configuration. In particular, at present, it might be not possible to use larger diameter single pipe or Pipe-in-Pipe (PIP) SCRs on some fields, where smaller diameter freehanging configurations are at present used. This is, because the selection of a simple (freehanging) catenary configuration would have resulted in very high hang-off loads. These would have become even higher in a case of an accidental flooding of the line with seawater that might inadvertently happen during installation or in operation. In such cases using a freehanging catenary might be impossible, because the excessive hang-off load resulting might be too high to handle. Similarly, there might be no installation vessel available anywhere in the world, to handle such a heavy pipe during its installation; or in particular to handle such a large diameter pipe or PIP, in a case of an accidental flooding with seawater. The feasible solutions in such cases would be to use wave or ‘S’ configurations, decrease loads with auxiliary buoyancy, or to use a larger number of smaller diameter lines that are lighter, so that the maximum tension loads can be handled.

To summarize lazy wave, steep wave, pliant wave, lazy and/or steep ‘S’ configurations according to prior art are used primarily because of two sets of reasons:
In shallow water in order to deal with large horizontal motions of their top supports in waves and/or currents;
In ultradeep water in order to make large (tensile) loads manageable;
An added advantage is some reduction in touch-down or bottom end dynamics.
   It is noted, that the average effective tensions at the top of the lower negatively buoyant segments of lazy and steep wave and ‘S’ configurations are typically of similar order of magnitude as those at the line hang-offs. It is also noted, that for the same reasons using modified wave or/and ‘S’ configurations featuring more than one buoyant segment (buoy) are known. In such cases the subdivisions of the negatively buoyant segments of the catenaries is in known designs in segments featuring comparable lengths and comparable maximum tension loads resulting from similar design philosophy as that used for the design of the single wave and/or ‘S’ configurations. This is because of the same reasons of maximizing the flexibility of the line (shallow water) or minimizing the maximum loads (ultradeep water). However, it is noted that:
The use of the configurations in question, as implemented in prior art, results in the increase of the suspended lengths used (and in the corresponding increase in costs of the installation that adds to the cost of the associated ‘additional’ hardware used);
The selection of one of these configurations in prior art is because of one of the underlying reasons listed above; in the prior art these line configurations are not selected because of the said added advantage. The reasons are economical, as specified directly above.

Because of their higher costs, the energy industry tends to avoid using said wave or ‘S’ configurations in conditions where simple catenaries can be made feasible. However, even for lazy wave, lazy S or compliant wave configurations, where partial dynamic decoupling can occur, Barltrop¹ states that touchdown line movements could also be significant.

Another known way of obtaining a partial reduction in the said line touchdown dynamics is a partial decoupling of motions by using a clump weight low on a catenary. This method tends to be only partially effective, because this makes the catenary above the clump weight steeper and it can result in the heave motions being transferred more easily down to the location of the clump weight. It also increases both the mass and the kinetic energy of the system moving, which would also tend to work in the opposite direction to that, which is desired. However, due to the enhanced dynamic decoupling effect in this solution together with careful tuning of the mass added and of its location to the particular dynamic wave spectra prevailing on a field, a partial improvement can be achieved.

### BRIEF SUMMARY OF THE INVENTION

Undersea dynamic motion of a line, cable, pipe, riser or the like is modified by the attachment of devices which locally change the buoyancy, the submerged weight, enhance the effective mass and modify drag damping of the line at selected locations. Certain mass-enhancing devices according to the present invention effectively add mass without being particularly massive themselves.

The size, shape, number and position of the mass/drag-enhancing devices may be varied to optimize the motion suppression effect. In particular, a novel line configuration is described in this specification that optimizes the use of buoyancy (depicted in FIG. 1), submerged weight, mass, added mass and drag in a particularly beneficial way.

The novel line configuration that optimizes the use of distributed submerged weight together with mass, added mass and drag is depicted in FIG. 2.

The said novel configurations depicted in FIGS. 1 and 2 are modifications of a conventional simple (free hanging) catenary configuration, in particular, they can be used in new systems or they can be retrofitted on existing flexible, or rigid (steel, titanium, aluminum, etc.) free hanging catenary lines. The said novel line configurations can utilize known types of buoyancy or can utilize novel buoyancy shapes as also introduced in this specification and in the commonly-owned patent application entitled “Catenary Line Dynamic Motion Suppression” filed simultaneously herewith. The novel feature of the said configurations is that the locations along which the said devices are installed on the lines are located in the areas of relatively low effective tension. This includes the said installation locations lying on the said lines in the vicinity of the seabed.

It is noted, in particular, that the novel configurations depicted in FIGS. 1 and 2 have been obtained by modifying simple, free-hanging catenary line designs, without adding any line lengths in comparison with those of the original simple catenaries. These were done so in order to demonstrate the suitability of this novel design to be used for retrofitting existing free hanging catenaries. Using the line length equal (or nearly equal) to that of a free hanging catenary is not, however, necessary to the practice of this invention.

However, the average effective tensions at the top of the line segments between the distributed buoyancy in FIG. 1 (5) or distributed submerged weight in FIG. 2 (5) in these novel designs are significantly lower than those at the line hang-offs.

Many implementations of the said novel buoyancy and weight clamp shapes according to this invention are also good Vortex Induced Vibration (VIV) suppressors. Accordingly, in addition to and instead of the use as wave dynamic suppressors they can also be used as primary or/and exclusive VIV suppressors.

### BRIEF DESCRIPTION OF THE SEVERAL VIEWS OF THE DRAWINGS

FIG. 1 is an illustration of a catenary line (3) suspended from a bow turret (2) of an FPS or FPSO vessel (1). FIG. 1 depicts also a line clamp of a known design (6a) and eleven example implementations of motion suppression devices according to the invention (6b through 6l). The example devices shown (6) feature a positive overall line buoyancy along the segment, where they are installed. The function of the catenary line shown is immaterial. It can feature an SCR, a flexible riser, an umbilical, a cable, a hose, a bundle of several similar or different lines, etc.

FIG. 2 depicts a catenary line (3) suspended from a semi-submersible platform (1). FIG. 2 depicts also a line clamp of a known design (6a) and eleven example implementations of motion suppression devices according to the invention (6b) through (61). The example devices shown (6) feature neutral or negative overall line buoyancy along the segment, where they are installed. The function of the catenary line shown is immaterial. It can feature a Steel Catenary Riser (SCR), a flexible riser, an umbilical, a cable, a hose, a bundle of several similar or different lines, etc.

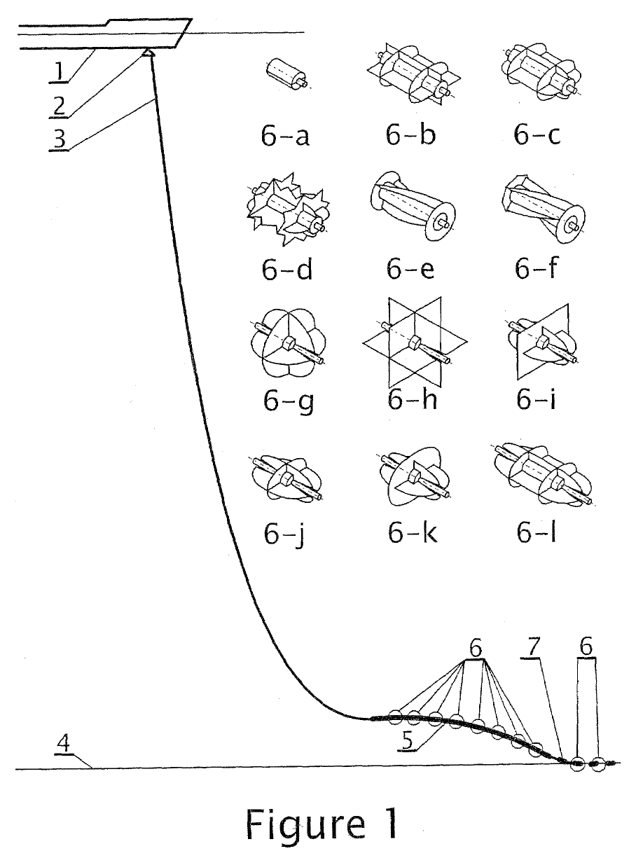

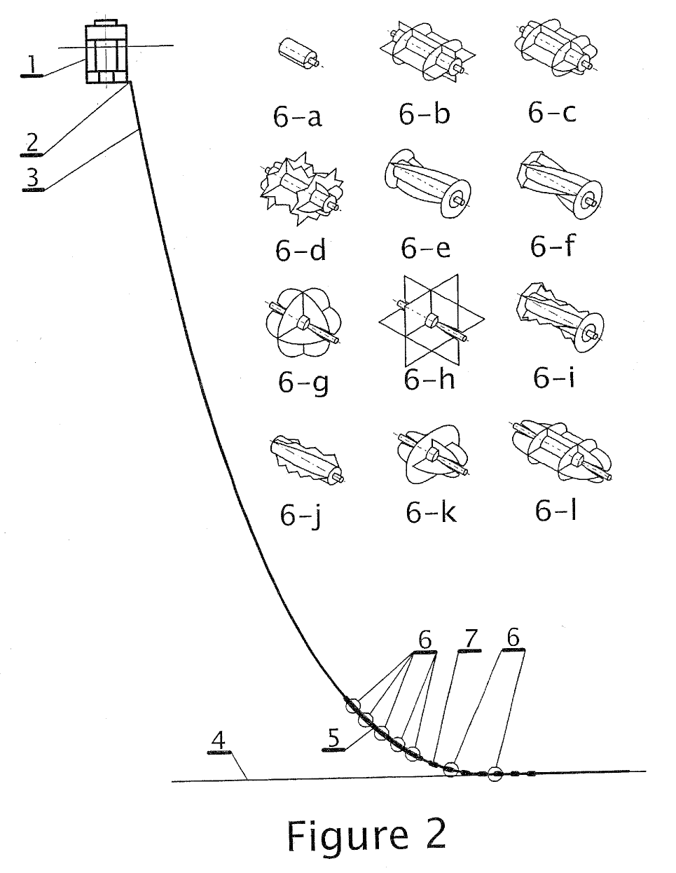

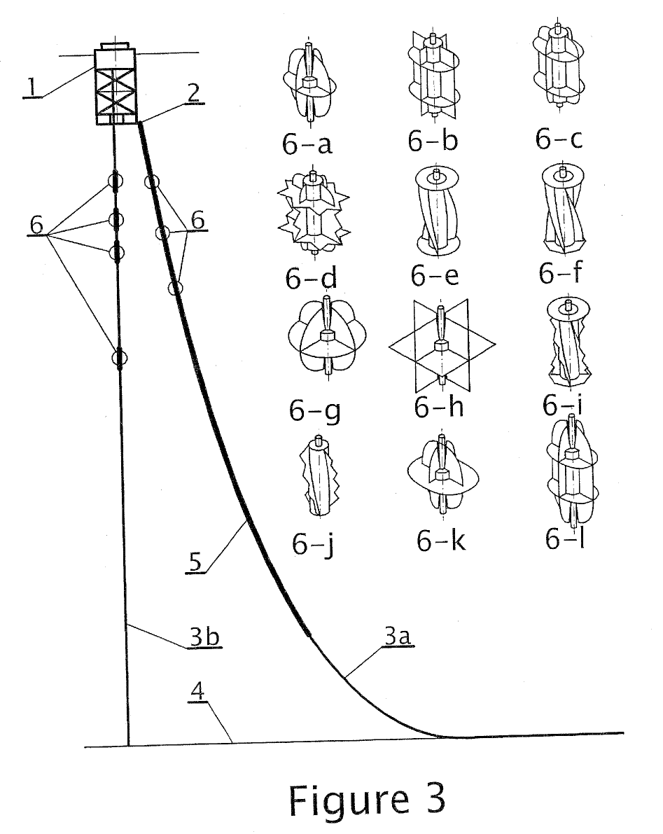

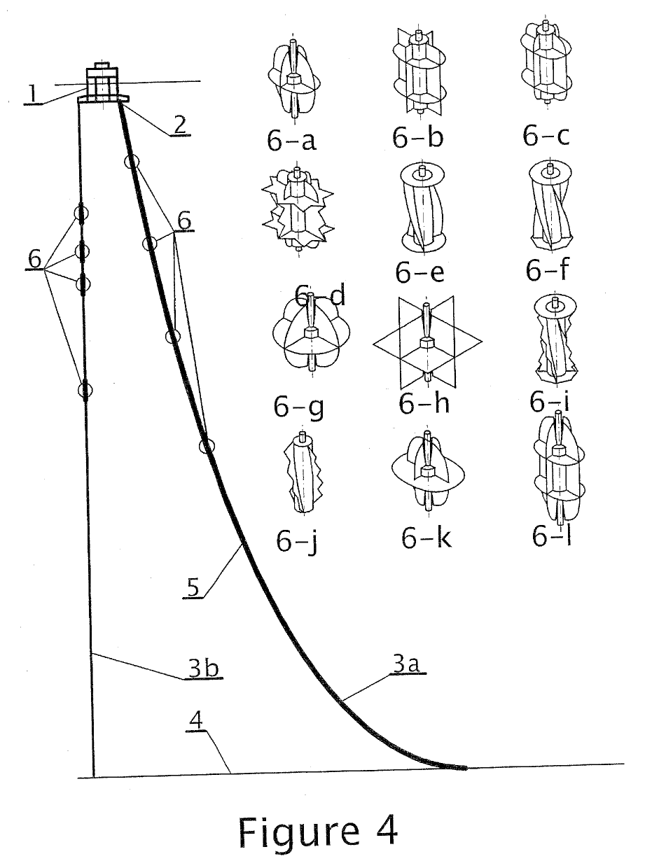

Optionally, the configurations shown in FIG. 1 and or FIG. 2 can also feature devices type (1a through 4l) mounted in the touch down region (7). The said optionally mounted devices in regions (7) could stretch beyond the touch down points, where they would be in contact with the seabed (4), see FIGS. 1 and 2. The said optional devices installed like those shown in regions (7) of FIGS. 1 and 2 could be installed on any line configuration in order to mitigate the said line dynamics in the touch down regions, including those installations where the elastic behavior of the seabed is relevant to the design.

FIG. 3 shows a SPAR platform (1) having a catenary line (3a) and a tensioned line (3b), both equipped with motion suppression devices (6). Segment (5) along the catenary line, to which devices (6) are attached, is selected by the designer for the purpose of motion suppression. The catenary line is suspended from a hang-off (2) and its lower end is supported by seabed (4).

FIG. 4 illustrates a TLP (1) having motion suppression devices (6) according to the present invention on both a catenary line (3a) and on a tendon (3b). Segment (5) along the catenary line, to which devices (6) are attached, is selected by the designer for the purpose of motion suppression. The catenary line is suspended from a hang-off (2) and its lower end is supported by seabed (4).

### DETAILED DESCRIPTION OF THE INVENTION

This invention allows the designer to locally fine tune several physical properties of lines, so that the desired motion suppression effect is achieved. The key line physical properties involved are the following:
Mass per unit length,
Added mass per unit length (described in terms of the added mass coefficient),
Submerged weight and buoyancy per unit length,
Drag coefficient.
   The above combined properties of the line, on which known or/and novel devices are mounted combined with the properties of the said devices are of importance herein.

The above properties affect the statics and dynamics of said lines in complex ways that have been outlined with regard to the prior art pertaining to the use of clump weights and buoyancy. This invention extends the tools available to the designer by allowing more control over the remaining said line physical properties, as well as more flexibility in shifting between the added and the actual mass per unit length as well more flexibility in utilizing the weight, the submerged weight and the buoyancy per unit length of the line.

In addition to extending the design tools, as already noted, this invention provides the designer with more opportunity to fine tune the design involving the said lines in offshore engineering.

The following general observation with regard to the properties utilized according to this invention are noted:
The effects of the submerged weight and the buoyancy are static.
The effect of the drag is static, quasistatic and dynamic.
The effects of the added mass and the mass are dynamic.

Motion suppression involves dynamics, whereas Newton's Second Law applies. Newton's Second Law implies in particular that greater mass provides greater ‘resistance’ to acceleration, and vice versa. The action of the hydrodynamic drag from the dynamic point of view is similar, however, relative motions between a location on the line and the surrounding mass of water matter:
wherever the line motion attempts to be faster than that of the surrounding water, the line motion is decelerated;
whenever the line motion is slower than the relative motion of the surrounding water, the line motion is accelerated by the transfer of momentum from the water to the line.

It is contemplated that the dynamic interactions involving a motion suppressor according to the present invention take place simultaneously in all three dimensions (and arguably in all six dimensions including rotations that are also relevant to some extent) between the line and the surrounding water, as well as due to the transfer of momentum and energy along the line, in complicated ways. These involve propagation of various kinds of the said waves, and their partial reflections at the ends, at locations along the said lines as well as in interactions with the bodies interacting, like the seabed, structures attached and the water surrounding. The said ways are propagated along the lines in ways that can be partly approximated as one dimensional—predominantly along the lines, but there are also important two dimensional effects that happen independently in the IP and OOP directions, wherever the line direction changes.

This invention utilizes the said four line properties as they simultaneously affect said complex six, three, two and one dimensional processes that are mostly dynamic and quasistatic. As the result of utilizing the invention static, quasistatic and dynamic results are achieved, the primary objective being dynamic motion suppression.

The said dynamic motion suppression has the combined purpose as follows;
The reduction in the dynamic component of the effective tension,
The increase in the lowest values of effective tension anywhere along the line,
The reduction of line susceptibility to global and local buckling, including buckling resulting from local interactions of different layers, components of layers involving the line construction, if applicable,
The increase in the minimum dynamic radius of curvature anywhere along the said line,
The reduction of the fatigue damage and associated increase in the fatigue life of any line components, including those of the internal line construction, if applicable,
The reduction in the range of variable stress components in the said line, including stress components in different line construction components, made of similar or largely differing materials, if applicable,
The reduction in the line susceptibility to bird-caging.

For the purpose of this invention dynamic line excitations can be divided into two categories:
Approximately periodic that can be well approximated with regular, i.e. close to sinusoidal excitations, typically in one to six degrees of freedom;
Transient Excitations, also typically in one to six degrees of freedom.

Regular excitations of very long and/or highly damped lines, whenever standing wave patterns are not generated, are considered as transient excitations for the purpose of this specification.

Real line excitations in offshore conditions typically combine both the said excitation categories. The said combination is typically non-linear and accordingly the load superposition does not apply in general, however, in many practical load scenarios it can be useful to consider a linear approximation of the dynamic system considered, which is a simplification of the real line and its dynamic loading.

Unless the line is very long or damping is very high, the said periodic excitations often generate standing wave patterns on said lines. A linear approximation of the standing wave component of the loading of a line allows the designer to use the following simple guidelines in dealing with the said standing wave loading of the said line:
Maximize drag per unit length along the line segment where the said devices are installed;
Depending on whether the design objective is to reduce line dynamic motions within line regions where the said devices are or are not installed:
   Minimize the combined mass and added mass per unit length along the line segment where the said devices are installed, in cases where the objective is to reduce the line dynamic motions along the bare line segments;
   Maximize the combined distributed mass and added mass per unit length locally, along the line segments, where the said devices are installed, in cases where the objective is to reduce the line dynamic motions of the said line segments where the devices are installed.
If feasible, tapering of combined line properties should be considered, whenever they change; these include in particular combined bending stiffness of the line and devices added (i.e. use of bending restrictors and/or bending stiffeners, and/or stress joints and/or tapered or stepped transition joints). Tapering other properties like the submerged weight, buoyancy, drag, mass and added mass might also be worth considering. Varying any properties can be achieved in particular by varying the number of devices used per unit line length and/or by modifying physical properties of the said devices.

In all the said cases, the designer needs to consider in detail the particular dynamic and hydrodynamic characteristics of the line being designed, the dynamics of any structures or other bodies relevant as well as the character of loading and the way it is propagated along the line. In particular, the line drag, mass and/or added mass per unit length can be utilized to suppress motions. Tapering of the said line properties can be also utilized and in general case the design needs to be evaluated and optimized using mathematical modeling. Commercially available line modeling programs are very useful for this purpose and they allow to model both the standing wave and transient load component.

The design evaluations and/or optimizations generally involve a number of design load scenarios (or loadcases) and the design and/or optimizations are performed in an iterative process (essentially by trial and error) until the design objectives are achieved or until the optimal system configuration is found.

Referring now to FIGS. 1 through 4, a variety of devices according to the present invention are illustrated. These devices are mounted on, rigid (steel, etc.), flexible and tensioned risers, umbilicals, cables, tendons or the like (hereinafter “line”). The devices shown are used for tuning locally the overall line submerged weight (including the buoyancy), mass per unit length, added mass per unit length, drag and bending stiffness of an associated line segment.

FIGS. 1 (6a) and 2 (6a) depict motion suppression devices of a known design are installed concentrically on lines 3. The devices shown are effectively mechanical clamps attached to the lines using any known means, (utilizing bolts, tape straps, adhesives, welded in place, etc.). Motion suppression devices of known design may feature a large variety of shapes and mounting arrangements, the split-cylindrical one shown for example is the most common one.

FIGS. 1 (6b) through (6l) and 2 (6b) through 4 (6l) depict example embodiments of the invented shapes. Attached to the exterior surface of the clamps are external plates, which may intersect at a large variety of angles (including right angles).

The said plates act to increase the overall added mass and hydrodynamic drag of the devices to which they are attached, and accordingly to increase locally the added mass per unit length of the line, and to increase locally the selected drag force components per unit length of the line, including all drag force components.

The size and shape of the novel devices are designed to increase the added mass and the hydrodynamic drag of the line to the arbitrary level required by the designer. The increase in the added mass is because of the dynamic pressure distribution on all external surfaces (including the plates) of the device, whenever the motion of line and the device changes relative the surrounding fluid (relative acceleration). This manifests itself as if an additional mass of water were entrapped, and moved together with the line and the device. The actual mass, weight, submerged weight and buoyancy of the device the plates included, also contributes locally to the actual mass, weight, submerged weight and buoyancy per unit length of the line.

It is noted that the example embodiments of the novel devices depicted on the said FIGS. 1 (6b) through 1 (6l) and 2 (6b) through 4 (6l) are examples only that illustrate the novel design principle involved. The novelty involved is functional and the actual number of realizations possible is much greater than it is practical to depict on drawings in this specification. However, selected design options and design features are discussed briefly further in this specification.

The present invention provides a riser, umbilical, jumper, cable and hose motion suppressing arrangement for use primarily but not exclusively in deepwater. This invention pertains to lines including flexible risers, umbilical lines and cables including any combination of electrical lines, hydraulic lines, pneumatic lines, fiber-optic lines, telecommunication lines, acoustic: lines and any other kind of lines that are used in offshore technology. This invention also pertains to hose lines, jumper lines, Steel Catenary Risers (SCRs), tensioned risers, including freestanding tensioned risers and hybrid riser towers, Said invention also pertains to hybrid risers and umbilical lines that might include any combinations of flexible and rigid (steel, titanium, aluminum and any other metal) lines, including tendons, and tethers. All said lines and other similar lines that are used in the offshore technology are referred herein as lines, which for the purpose of this specification include all types of lines identified herein and all types of bundles of lines, including riser bundles and pipeline bundles in operation, during their transport and installations. These also include any configurations of the said lines used offshore, inshore and in inland waters. High curvatures of said lines on some configurations, together with their low slopes may be utilized, see simple catenary line, FIG. 1. The original line configuration may or may not be modified. Known motion suppressing device designs can be used, see FIGS. 1 (6a) and 2 (6a). Because of the low slope on some configurations (line parallel or nearly parallel to the seabed), said motion suppressing devices can be installed on arbitrarily long line segments, which can be designed as long as necessary in order to achieve the design objections required. Novel, drag and added mass enhancing devices, see FIGS. 1 (6b) through 1 (6l) and 2 (6b) through 4 (6l), effective in all directions can be used to increase the suppression effectiveness and/or in order to reduce the number of devices used or to reduce the lengths of the motion suppressing segments. This invention is suitable for use on new designs and it is also suitable for retrofitting on existing, already installed lines.

This invention is illustrated further below in examples of use of the invented device for a motion suppression of simple (free hanging) catenary configurations of risers, cables or umbilical lines, see FIGS. 1 and 2. Similar devices would also be effective while used in various locations of other configurations on other types of lines, in particular on lazy wave, pliant wave, and/or steep wave configurations as described for example by Baritrop¹.

Two similar example implementations, shown in FIG. 1, of this invention are illustrated herein. A similar implementation of this invention using motion suppressing devices according to this invention having positive submerged weights is shown in FIG. 2. These examples are used herein to demonstrate this invention and to highlight the design reasoning involved. All three examples described herein involve optimizations of this invention for modifications of the simple catenary line configurations according to this invention. Simple catenary configurations are those that experience dynamic touch-down conditions that are the most difficult to deal with, at least in deepwater.

The original simple catenary line according to a known design and both modified configurations optimized according to this invention used the same flexible line characteristics, including the same submerged weights, the same axial and bending stiffnesses as well as the same outside diameters and allowable minimum radii of curvature in dynamic conditions. All these parameters typically vary in wide ranges depending on particular design objectives required. Similar results to those demonstrated by mathematical modeling of the known design, and the new designs according to this invention can be obtained for other lines characterized by other sets of design parameters. In particular, the two examples of the designs according to this invention used herein for the sake of a demonstration depicted in FIG. 1, were very similar, they had exactly the same quasi-static real catenary configurations of a riser or an umbilical, which are depicted in FIG. 1. In order to demonstrate, however the design advantages of this invention that occur even with widely varying technical characteristics, the drag coefficients and the inertia coefficients of the short, close to slightly positively buoyant segments (5) added to the catenary close to the touch-down differed considerably.

For the sake of the said examples the top ends of the line (3) were attached to a bow turret (2) of a floating tanker vessel (1). The seabed (4) was assumed to be horizontal. For the sake of the examples depicted in FIG. 1, a distributed, slightly positively line segment (5) was utilized as an implementation of the invented arrangement in order to suppress line dynamics in the touchdown zone.

It is noted, that the devices designed according to this invention added to suppress motions could be positively buoyant (see FIG. 1), neutrally and negatively buoyant (see FIG. 2), could be distributed and could be placed in discrete locations, depending on the design objectives of the designer, including but not being limited to the degree of modification of the variations of average components and to the extents of variations in the dynamic components of technical parameters, for example the said effective tension and for example the said minimum radius of curvature. The devices installed on the lines should preferably be located within the lower ⅜ of the line suspended length, but they can be installed as low on the lower ⅓, ¼ or even ⅛-th of the line suspended length from the location of the touch down or from the location where the line is connected to its lower end attachment.

The said original and both the said modified catenary configurations in the examples shown on FIG. 1 use the same top of the line departure angles from the horizontal. While one uses the catenary line approximation of a real line shape, it is noted that for a given water depth, with a given top line support elevation and a given average slope angle of the seabed the IP shape of an ideal catenary line is uniquely defined and it is described with an algebraic mathematical equation involving a hyperbolic function cosh. Accordingly, the top departure angle is a convenient parameter to describe shapes of real lines used offshore.

It is also noted that said top catenary angles used in offshore engineering vary in a wide range, depending on the water depth and sets of other parameters that depend on particular design objectives, types of the surface structures used and their motion characteristics, if relevant, types of lines used, configurations of other, neighboring lines that need to be cleared, etc. In particular, on the high side it is common to use in deepwater, umbilical line nominal departure angles of close to 88° and to 89° from the horizontal, and both values up to 90° and much lower values are assumed by line catenaries used on several Gulf of Mexico Truss-SPAR platforms due to low and high frequency motions as well as due to shifting the platform mean location between various design parking positions. On the lower side it is mentioned that for example SCRs in not very deep water can use top departure angles lower than 65° or even lower than 55° and many mooring lines used have nominal top departure angles close to 45° and lower in deep water, and even considerably lower in less deep water. This invention can be used with many types of lines in many configurations having any top departure angle selected from a wide range by a designer.

This invention involves the design optimization process that extends beyond usual known design considerations combined with providing adequate, novel means to achieve the design level of motion suppression in key design areas of lines used in offshore engineering. In order to achieve a desired level of motion suppression according to this invention, drag damping and added mass are utilized. For the examples of the simple (free hanging) catenary lines demonstrated herein (FIGS. 1 and 2), the key regions of interest are the touchdown zones. The said properties of catenary lines that were already highlighted herein are utilized in a novel way according to this invention in order to achieve the design objectives required.

In particular, it is desirable to utilize drag and added mass along a line to an extent required. Near the touch down area, a simple catenary has its maximum design curvature. This makes the selection of the area adjacent to the touch down particularly effective in the maximizing of the motion decoupling process. In particular, using buoyancy or/and approximately neutrally buoyant drag and added mass enhancing devices according to this invention directly adjacent to the touch-down area are particularly advantageous novel ways in achieving motion suppression. That is more effective than using say a traditional lazy wave configuration just in order to deal with the touchdown dynamics, when there is no other, governing reason for selecting a lazy or pliant wave or a lazy S configuration.

In particular, it is noted, that in the touch-down area, the catenary line has naturally a small slope angle, in addition to the large curvature that is utilized to enhance decoupling. Clamping buoyancy on a line increases its drag and its added mass. Accordingly, it is natural to utilize the small slope together with the neutral buoyancy of a line segment that can be extended almost indefinitely to a segment length that is required to achieve the motion suppression desired. In order to compensate for the natural aging of most buoyant materials used, this means in practice a slight overall positive buoyancy of the line segment added. The additional advantage of the slight positive buoyancy is, that if desired so, the slight original downward slope of the catenary in the touch-down zone can be compensated with slight positive buoyancy, so that the average added segment slope can be modified to any desired downward, horizontal or upward value required, so that there is no physical limit to the selection of the length of that novel segment required according to this invention. Mathematical modeling proved, that while using buoyancy elements of known design, FIG. 1 (6a), which are featured with traditional values of the drag and inertia coefficients, effective tension compression (i.e. negative values of the effective tension) was removed for the line example depicted in FIG. 1, in spite of extreme seastate conditions used. Neither of the above was achievable while using the known simple catenary configuration for the tanker vessel motions and the typical line characteristics used. In addition to this, the minimum values of the radius of curvature were increased to those considerably above the allowable value. It is understood here that the inertia coefficient incorporates the added mass coefficient and also accounts for the Froude-Krilov forces on a body considered.

It is noted, however, that for the configuration, according to this invention depicted in FIG. 1, but utilizing buoyancy clamps of known design, FIG. 1 (6a), significant tensile (positive) dynamic components were present in the values of the effective tension and in the values of the radius of curvature. It is also noted, that in a similar modeling exercise with a short buoyant segment located slightly higher on the catenary, it was not possible to keep the effective tension positive throughout the modeling time span (irregular sea of pre-defined duration). However, by utilizing distributed buoyancy according to this invention as shown for example in FIGS. 1 (6b) through 4 (6l), the minimum radius of curvature in the dynamic line motion was increased to an acceptable value, see below.

The second example design according to this invention presented herein utilized drag and added mass enhancing devices according to this invention, like those depicted in FIGS. 1 (6b) through 4 (6l). The shape and the size of these devices can be designed to increase the drag and inertia coefficients considerably, see FIGS. 1 (6b) through (6l) for some examples. In general, the larger the dimensions of the shapes used, the larger the drag and inertia coefficients will be. These allowed significant improvements in the effectiveness of the drag and added mass suppression invented. It is noted in particular, that the local discrete or distributed increase in the added mass, could in theory, be as effective in decoupling motions as using a clump weight, however, the added mass of water does not have the undesirable effects of making the catenary steeper and transmitting the heave motions more efficiently to the lower regions of the line. Increasing the drag forces locally results in additional damping, i.e. dissipation of the oscillation energy transmitted along the line and stored in the vibrating system.

The use of the enhanced drag and enhanced added mass devices in the second example described herein, like the examples shown in FIGS. 1 (6b) through 4 (6l), resulted in additional large reductions in the dynamic components of the effective tension and increases in the minimum radii of curvature. In fact, the modeling demonstrated that the length of the modified segment (5), as shown on FIG. 1, could have been reduced considerably in comparison with that used and the improvements achieved would still be considerable.

Several examples of the drag coefficient and the inertia coefficient-enhancing shapes are depicted in FIGS. 1 through 4, but many more are possible and can be used in implementing this invention. There are so many configuration selection possibilities that it would not have been practically possible to demonstrate them all on drawings or to fully describe all the possibilities. Accordingly, a general description follows that highlights the outline of the possibilities existing. In particular any combinations of triangles, squares, rectangles, other polygons like that shown for example in FIG. 1 (6f), circles, ellipses, ovals, star-like shapes and many others in absolutely arbitrary combinations can be used.

The design arrangement according to this invention of the shapes used for the drag and added mass enhancements is important. Because said line motions in the touch down regions are three dimensional, or to be more precise five dimensional if one adds rotations IP and OOP, the shapes used according to this invention provide the drag and added mass enhancements that are simultaneously effective in more than one direction and preferably in any three directions, that would be affected approximately similarly to three mutually perpendicular directions. In particular, the drag and added mass enhancements according to this invention are recommended to be effective in the axial direction and simultaneously in both IP and OOP directions of the catenary. However, any other selection of directions can be used if that selection has a similar effect. Numerical modeling shows that drag enhancing only in the axial direction, for example that suggested by U.S. Pat. No. 4,909,327, enhancing drag in the axial direction of a line is not very effective.

The areas and the aspect ratios of said devices that enhance the drag and added mass in differing directions need not be the same, in fact in the general case they would be different, see FIGS. 1 through 4. The aspect ratio is defined herein as the square of its maximum dimension presented to the flow divided by the surface area of a given shape presented to the flow along the mean normal vector to the surface of the shape (this is equal to the ratio of the effective span length of the shape to its mean chord length). For instance, for a square and a rectangle the said maximum dimensions are the lengths of their diagonals.

Three dimensional arrangements of the drag and added mass enhancing features can be very complex. In particular, in addition to predominantly planar appendage shapes that are shown in FIGS. 1 (6b) through (6l), curved shapes, in general featuring both curvatures and twists can also be used. For example, FIGS. 1 (6e) and 1 (6f) depict helical strakes. The shapes can feature smooth or rugged edges, like those shown for example in FIG. 1 (6d), FIG. 2 (6d and 6i through 6j), FIGS. 3 and 4 (6d and 6i through 6j). Any of the added mass and drag enhancing devices described herein can also feature drag and/or added mass enhancing holes and/or slots that could in some situations be more effective than solid shapes, similarly to holes and/or slots that are used in the designs of some parachutes.

The use of the drag and inertia coefficient enhancing shapes according to this invention provides a designer with several additional design optimization tools according to this invention:
Selecting the actual shapes and the design parameters of the motion suppressing shapes, while having additional design philosophy aspects in mind, for example the OOP shape of the catenary in case of a significant cross-current, VIV suppression, etc;
Selecting the appropriate shape dimensions for the level of suppression required;
Balancing between the effectiveness of the shapes, buoyancy, submerged weight used, the length of the motion suppressing segment and/or the number of said suppressing devices used, etc.

Three important design philosophy aspects might need to be considered in the design of the drag and added mass motion suppressing arrangement according to this invention. They are both related to a particular current profile.
The first one regards the way drag in a current affects the shape of the design catenary;
The second one is related to the way any design modifications according to this invention would affect VIVs of the line, if relevant;
The third is that the drag and added mass enhancing devices described herein can be used anywhere on lines also with the primary purpose of VIV motion suppression.

On most field locations currents tend to decrease with the water depth and they tend to become even weaker near to the seabed. These tend to be beneficial, because local drag increases would tend to result in smaller distortions of the line shape, than those that might occur for example in lazy or pliant wave configurations. However, the above is not always the case, on some location's bottom currents could be particularly strong. In such situations these aspects need to be included in the design process and the locations of the drag and added mass motion suppressing arrangement might need to be moved higher along the catenary. It is noted, however, that this does not necessarily need to be the case, the dissipating effectiveness of hydrodynamic drag improves with increasing current. The effectiveness of the added mass suppressing component in a current might require additional consideration and designer's attention in a case of a current. The actual shapes used for the suppression enhancement might be of importance in this context.

With regard to the VIV potential, it is noted that in general both the use of buoyancy of known design (FIGS. 1 (6a) and 2 (6a) and/or that having invented shapes (FIGS. 1 (6b) through 1 (6l) and 2 (6b) through 4 (6l) for additional motion suppression will tend to improve the VIV situation, because of the local decrease in the reduced velocity, due to the increase in the hydrodynamic diameter. The additional improving effect of the increase in the hydrodynamic diameter would in most cases be increased drag damping, which would tend to increase the damping of the whole dynamic system. In fact, unless the current is very strong the designer of a system according to this invention has additional tools to reduce the VIV susceptibility of the entire dynamic system. The additional tools involve the freedom to use beneficial hydrodynamic diameter in order to reduce locally the reduced velocity, use of beneficial shape configuration to increase the hydrodynamic damping in the system, as well as shaping the damping appendages so, that additional vortex generation suppression results. The latter could include adding helical pitch to the design of the shapes, see for example FIGS. 1 (6e) and 1 (6f), in order to provide them with added vortex suppression effectiveness, using rugged edges like those depicted for example in FIGS. 1 (6d), etc. The issue of the added mass could be more complicated in case the invented suppression area increases the VIV energy of the system. In such cases added mass could be even negative and additional, more complex optimization considerations could be necessary. Accordingly, the general guideline is to try to reduce the reduced velocity in the regions designed for the motion suppression and consequently to enhance their effectiveness both in the wave oscillation frequency range and in the VIV frequency range.

It is noted that known strake designs used in order to suppress VIV (like those shown for example in U.S. Pat. Nos. 6,695,540B1 or 6,896,447B1), would in principle have different geometrical features than strakes designed to enhance the drag and added mass according to this invention. Many) geometries of VIV suppressing strakes are used in the offshore technology, some had never been model tested before the installation in the ocean. However, those strake designs that are justified by extensive model testing programs and many years of research tend to have strake height to root diameter ratios of the order of 25% or lower. Usually, three strakes are arranged on the circumference. Typical configurations have pitch of the order of 17 times the root diameter.

However, some European tests recommend strakes of the pitch three to four times smaller. These tend to result in less effective VIV suppression, but the drag of the line tends to be smaller. Generally, VIV designers try to optimize the VIV amplitude reduction effectiveness with minimizing the hydrodynamic drag of the strakes. These objectives are different from those desired herein, and accordingly the designs resulting would preferably differ. In particular, if helical strakes are utilized according to this invention, they would preferably be also fitted with axial drag increasing plates, like those depicted for example in FIGS. 1 (6e) and 1 (6f) that are not used on VIV suppressing strakes. In addition to this, it is noted that maximizing the drag and the added mass would tend to favor higher height-to-root-diameter ratios. In particular, those strakes shown in FIGS. 1 through 4 have the height-to-diameter ratios on the order of 50%, and even higher fins could be used.

The strake heights and other features would typically be affected also by other considerations like a manufacturing process used, economic considerations, installation configuration limitations, etc. that might tend to reduce the height of the strakes used in any particular design. Also, drag is better enhanced if more than three fins are used on the device circumference, in particular the example depicted in FIG. 1 (6f) uses for sake of instance four fins, while that of FIG. 1 (6e) uses only three fins; using other numbers of fins is also feasible.

It is noted that other shapes according to this invention also have high VIV suppression effectiveness, in particular the shapes utilizing rugged edges. These shapes can feature rugged contours, with or without helical twist. Rugged contours result in forcing wake vortices to be shed at particular lengths, which can be varied by the designer by selecting irregular ruggedness patterns or/and by mounting devices on lines at irregular intervals.

Arbitrary geometrical shapes can be used in many implementations of this invention. The said shapes can intersect at arbitrary angles, including a wide range of acute angles and right angles. It is understood herein, that any flat or curvilinear surfaces intersecting at other than a right angle will define at least two values of angles, the governing one of which will be an acute angle and the other one being 180° minus the said acute angle.

It is also noted that manufacturing and installation limitations can also limit the size of any shapes used. In general they can have simple construction or they can be strengthened with ribs, they can use fiber reinforcement technology, they can utilize strengthening brace members, etc., none of which are shown for the sale of simplification in FIGS. 1 through 4.

In particular installation or transport requirements would often affect the detailed design of the said novel shapes. In particular, the designer might decide to provide the said devices with additional strengthening, for example additional ribs or braces that would provide additional protection or/and increase the bearing strength of the said devices, with regard to contact with external bodies. This could be demanded by a need to withstand contact loads with other equipment for example with a stinger of an installation vessel, with a ramp, with a J-lay tower components, a contact with a beach during launch, an interaction with the seabed during a bottom tow, in the touch down area during operation, etc.

It is noted that the devices used might use split clamp design (symmetrical, or asymmetrical, including designs that are split on one side), the details of which are also omitted for clarity from the isometric views presented in FIGS. 1 (6b) through 1 (6l) and 2 (6b) through 4 (6l). It is noted that any materials and construction principles used in subsea engineering are suitable for use to design and to build said drag and added mass enhancing devices. Devices of the same and of mixed technical features can be used on the same line, if so required. They can be mixed along the line, or in particular their technical characteristics including the shapes, material densities, drag coefficients and added mass coefficients can be modified gradually along said line or lines in order to achieve any particular design objectives required. Optimizations using mathematical modeling are useful and cost efficient, however, specific model testing programs would be a useful design optimization tool.

It is noted that with some sets of design requirements including the design requirements on the line properties, the met-ocean conditions and the characteristics of the top support structure (i.e. vessel, buoy, etc.), it might be relatively easy to configure the design arrangement according to this invention, so that the dynamic compression is removed or reduced to a desired level. However, particularly in ‘more challenging’ irregular sea conditions it might be more difficult to optimize the design to limit dynamic bending as well.

In cases where the reduction of the minimum radius of curvature beyond that easily achievable by using the said dynamic decoupling arrangement according to this invention alone is less easy than dealing just with dynamic compression, it might be advisable to use also traditional stress joints (with uniform or varying properties, including tapered and stepped stress joints), bending restrictors or bending stiffeners, etc., as desired, at one or both ends of segments where the added mass and/or drag properties and/or submerged weight (buoyancy included) are modified.

Bending stiffeners and/or bending restrictors and/or uniform and/or tapered stress joints can be used with segments having constant or/and variable said modified line properties along the segment length. In particular, tapering of the line properties towards one or both segment end(s) can be utilized. What is meant here, is also using mass, added mass, drag coefficient, submerged weight, buoyancy, etc. that are variable along the line, according to this invention, alone or/and together with traditional means to govern bending, like those provided by traditional stress joints, tapered transition joints, bending stiffeners, bending restrictors, etc. These include combining the said uniform or said variable line properties according to this invention, with those of the said traditional bending control devices. The said combining can be performed so, that:
The said bending control devices can be installed at an end or at both ends of the segment(s) having modified properties, according to this invention;
The said segment(s) having modified properties, according to this invention can be simultaneously featured with modified bending properties, so that they can also perform like a traditional bending restrictor or bending stiffener;
Stress joints and/or stepped and/or tapered transition joints can be used at the locations with modified hydrostatic and/or hydrodynamic line properties according to this invention and/or they can be used at adjacent location or locations.

The physical properties of line appendages, whether of known or novel design are determined in the design process in the usual way using the densities of the materials selected and their dimensions, which result in volumes that can be calculated. The said physical properties include:
mass of the said appendages per unit length of the line,
weight in air of the said appendages per unit length of the line,
buoyancy of the said appendages per unit length of the line,
submerged weight of the said appendages per unit length of the line.
   Of course, the said submerged weight is equal to the difference between the weight and the buoyancy.

The added mass per unit length and the drag coefficients of appendages of known design as well as those of some of the isolated shapes added to the appendages of novel design presented herein are known (or in the latter case they could be known approximately) from technical literature, like DNV CN30.5³. However, in most cases, the remaining hydrodynamic properties of the said appendages:
the added mass of the said appendages per unit length of the line (the added mass coefficient),
the drag of the said appendages per unit length of the line (the drag coefficient),
   are determined from hydrodynamic model tests. The hydrodynamic model tests would in many cases include some variations of the geometries of the appendages tested. ³Environmental Conditions and Environmental Loads, Det Norske Veritas, Classification Note No. 30.5, DNV CN30.5, March 2000.

Knowing the above properties, the designer refines the design of the dynamic motion suppression of the line using mathematical modeling. This is performed using specialized computer programs (including those commercially available) or equivalent (the ‘equivalent’ might include customized databases prepared previously using mathematical modeling, etc.). The refining process typically involves parametric studies including the variation of the said line property parameters specific to the specific design criteria of the line until the desired or optimal line suppression design is achieved. The said design criteria of the line would typically include for example: water depth; base line properties and geometry; platform, buoy, etc motions; wave climate, current profile; clashing potential with other lines and equipment; etc.

In order to suppress the line dynamics according to these guidelines, the designer typically maximizes the drag along the line. With regard to the line effective mass per unit length, the general guideline is to maximize it to the extent feasible in the regions where the greatest dynamics occurs, in particular the transverse line dynamics. However, the limitation on the said increases in the effective mass by using said devices type (FIG. 1-6a through 4-6l) tend to increase the standing wave dynamics along the bare segments of the line, where relevant. The designer needs to fine tune the design, while talking into account the above counteracting tendencies. Important additional design tools are tapering the said line properties, including using bending stiffeners, restrictors, stress and transition joints, etc. as described herein.

In some cases variations of the design process outlined above can be selected instead, while still including in principle the major action components described above. This could include for example refining the said line properties in the preliminary design process and subsequently using hydrodynamic model testing in order to refine the specific said line appendage properties.

Whichever design ‘flowchart’ is used, the design process typically includes several design iterations. Model testing iterations might also be required, a tendency is to keep a number of these to a minimum.

In addition to the above mentioned, the design iterations typically deal with a number of usual design issues like static and dynamic positive and negative effective tension, allowable bending moments, minimum radius of curvature, maximum dynamic stresses, fatigue, as already described herein, etc.

This invention involves:
Dynamics decoupling, damping and added mass enhancing arrangement,
   including a single device,
   and also including a system of multiple devices,
   and also including any plurality of systems of such devices,
which affect line dynamic motion in marine engineering.
Said line including: any flexible riser, any umbilical, any cable, any mooring line, any tether, any tendon, any hose, any jumper, any tensioned riser including free standing risers, any hybrid riser tower, any steel catenary riser, any rigid riser made of another metal, including any plurality of metals and alloys, including titanium and aluminum.
Said line being made of any other natural, and said line being made of any other man made rigid material, and said line being made of any man made flexible material, and said line being made of any other natural rigid, and also including said line being made of any other natural flexible material, and said line being made of any combination of manmade, natural, flexible and rigid materials.
Said line having predominantly one kind of construction, and including said line being of hybrid nature and incorporating said lines having differing line constructions, including line segments having differing line constructions.
Said arrangement in particular:
   utilizing buoyancy,
   and also said arrangement utilizing submerged weight,
   and also said arrangement being approximately neutrally buoyant
Whereas any of said positively, negatively and neutrally buoyant devices utilizes also:
   its own mass
   in addition to its added mass
   and in addition to the hydrodynamic drag it generates during its dynamic motions;
and also said arrangements in particular
   utilizing buoyancy,
   and also said arrangements utilizing submerged weights,
   and also said arrangements being neutrally buoyant.
Whereas any of said positively, negatively and neutrally buoyant devices, including arbitrary combinations of said positively, negatively and neutrally buoyant devices,
   utilize also their own mass
   in addition to their added mass and
   in addition to the hydrodynamic drag they generate during their dynamic motions.
Said arrangement utilizing natural catenary properties, said properties including in particular:
   relatively low average effective tension at and near the seabed end of said line catenary
   and also relatively low average effective tension directly above buoyant segments and buoyant arches and buoys of lazy wave, pliant wave, steep wave, lazy S, steep S, Chinese Lantern.
Said catenary line properties, which for said particular line configurations incorporating simple, free hanging catenaries, lazy wave and pliant wave catenaries and lazy S catenaries, might also include:
   a relatively high curvature
   combined locally with said relatively low average effective tension.
Said catenary line properties, which for said particular line configurations incorporating simple, free hanging catenaries, lazy wave and pliant wave catenaries, and lazy S catenaries might also include:
   a relatively low line slope with regard to the slope of the seabed,
   combined locally with said relatively low average effective tension.
Said positively buoyant device, and said neutrally buoyant device, and said negatively buoyant device, including any plurality of said positively buoyant devices, and said neutrally buoyant devices, and said negatively buoyant devices, which utilize:
   any of said catenary line properties alone, and
   which utilize any plurality of said catenary line properties.
Said relatively low average effective tension, including and excluding said catenary line properties, being utilized together with
   the mass of said device,
   including being utilized together with masses of any multitude of said devices
in order to reduce the dynamic component of said effective tension, including and excluding any negative component of said dynamic effective tension at any locality, including any localities, along said line.
Said relatively low average effective tension, including and excluding said catenary line properties, being utilized together with
   the buoyancy of said device,
   including being utilized together with buoyancies of any multitude of said devices
in order to reduce the dynamic component of said effective tension, including and excluding any negative component of said dynamic effective tension at any locality, including any localities, along said line.
Said relatively low average effective tension, including and excluding said catenary line properties, being utilized together with
   approximately neutral buoyancy of said device,
   including being utilized together with approximately neutral buoyancies of any multitude of said devices
in order to reduce the dynamic component of said effective tension, including and excluding any negative component of said dynamic effective tension at any locality, including any localities, along said line.
Said relatively low average effective tension, including and excluding said catenary line properties, being utilized together with
   the submerged weight of said device,
   including being utilized together with submerged weights of any multitude of said devices
in order to reduce the dynamic component of said effective tension, including and excluding any negative component of said dynamic effective tension at any locality, including any localities, along said line.
Said relatively low average effective tension, including and excluding said catenary line properties, being utilized together with
   the drag force on said device,
   including being utilized together with drag forces on any multitude of said devices
in order to reduce the dynamic component of said effective tension, including and excluding any negative component of said dynamic effective tension at any locality, including any localities, along said line.
Said relatively low average effective tension, including and excluding said catenary line properties, being utilized together with
   the added mass of said device,
   including being utilized together with added masses of any multitude of said devices
in order to reduce the dynamic component of said effective tension, including and excluding any negative component of said dynamic effective tension at any locality, including any localities, along said line.
Said relatively low average effective tension, including and excluding said catenary line properties, being utilized together with
   the mass of said device,
   including being utilized together with masses of any multitude of said devices
in order to increase the dynamic minimum in the variation in the line radius of curvature at any locality, including any localities, along said line.
Said relatively low average effective tension, including and excluding said catenary line properties, being utilized together with
   the buoyancy of said device,
   including being utilized together with buoyancies of any multitude of said devices
in order to increase the dynamic minimum in the variation in the line radius of curvature at any locality, including any localities, along said line.
Said relatively low average effective tension, including and excluding said catenary line properties, being utilized together with
   approximately neutral buoyancy of said device,
   including being utilized together with approximately neutral buoyancies of any multitude of said devices
in order to increase the dynamic minimum in the variation in the line radius of curvature at any locality, including any localities, along said line.
Said relatively low average effective tension, including and excluding said catenary line properties, being utilized together with
   the submerged weight of said device,
   including being utilized together with submerged weights of any multitude of said devices
in order to increase the dynamic minimum in the variation in the line radius of curvature at any locality, including any localities, along said line.
Said relatively low average effective tension, including and excluding said catenary line properties, being utilized together with
   the drag force on said device,
   including being utilized together with drag forces on any multitude of said devices
in order to increase the dynamic minimum in the variation in the line radius of curvature at any locality, including any localities, along said line.
Said relatively low average effective tension, including and excluding said catenary line properties, being utilized together with
   the added mass of said device,
   including being utilized together with added masses of any multitude of said devices
in order to increase the dynamic minimum in the variation in the line radius of curvature at any locality, including any localities, along said line.
Said relatively low average effective tension, including and excluding said catenary line properties, being utilized together with
   the mass of said device,
   including being utilized together with masses of any multitude of said devices
in order to increase the fatigue life of any component of said line, including any multitude of lines, including any internal component of said line cross section.
Said relatively low average effective tension, including and excluding said catenary line properties, being utilized together with
   the buoyancy of said device,
   including being utilized together with buoyancies of any multitude of said devices
in order to increase the fatigue life of any component of said line, including any multitude of lines, including any internal component of said line cross section.
Said relatively low average effective tension, including and excluding said catenary line properties, being utilized together with
   approximately neutral buoyancy of said device,
   including being utilized together with approximately neutral buoyancies of any multitude of said devices
in order to increase the fatigue life of any component of said line, including any multitude of lines, including any internal component of said line cross section.
Said relatively low average effective tension, including and excluding said catenary line properties, being utilized together with
   the submerged weight of said device,
   including being utilized together with submerged weights of any multitude of said devices
in order to increase the fatigue life of any component of said line, including any multitude of lines, including any internal component of said line cross section.
Said relatively low average effective tension, including and excluding said catenary line properties, being utilized together with
   the drag force on said device,
   including being utilized together with drag forces on any multitude of said devices
in order to increase the fatigue life of any component of said line, including any multitude of lines, including any internal component of said line cross section.
   Said relatively low average effective tension, including and excluding said catenary line properties, being utilized together with
   the added mass of said device,
   including being utilized together with added masses of any multitude of said devices
in order to increase the fatigue life of any component of said line, including any multitude of lines, including any internal component of said line cross section.
Said reduction including
   said reductions, in the dynamic component of said effective tension,
   including and excluding any reduction in said negative component of said dynamic effective tension,
at any locality, including any localities, along said line, including any multitude of lines, being achieved by said arrangement favorably combining said relatively low average effective tension, including and excluding said catenary line properties, with any combination of said mass, said buoyancy, said approximately neutral buoyancy, said submerged weight, said drag force and said added mass of said device, including any plurality of said devices of known design.
Said increase in said dynamic minimum in the variation of the line radius of curvature at any locality, including any localities, along said line, including any multitude of lines, being achieved by said arrangement favorably combining said relatively low average effective tension, including and excluding said catenary line properties, with any combination of said mass, said buoyancy, said approximately neutral buoyancy, said submerged weight, said drag force and said added mass of said device, including any plurality of said devices of known design.
Said increase in the fatigue life of any component of said line, including any multitude of lines, including any internal component of said line cross section, at any locality, including any localities, along said line being achieved by said arrangement favorably combining said relatively low average effective tension, including and excluding said catenary line properties, with any combination of said mass, said buoyancy, said approximately neutral buoyancy, said submerged weight, said drag force and said added mass of said device, including any plurality of said devices of known design.
Said use of novel devices according to this invention, which feature modified technical characteristics involving any combination of said mass, said buoyancy, said approximately neutral buoyancy, said submerged weight, said drag force and said added mass of said novel device anywhere along said line, including any pluralities of lines used and any multitudes of locations on said lines.
Said novel devices involving a use of arbitrary geometry shapes designed to increase hydrodynamic drag and added mass of said novel devices, in comparison with those of devices of known design used on said lines.
Said geometric shapes including any three dimensional arrangements of circles, ellipses, ovals, triangles, squares, rectangles and other arbitrary polygons, arbitrary star figures, helical strakes and any complex combinations of flat and three dimensional shapes.
Any and all of said shapes having smooth edges and any and all of said shapes having rugged edges.
Said shapes having
   solid flat shape areas,
   solid curved areas, which might incorporate a curvature,
   and which might feature twisting,
   and also said shapes featuring holes,
   said shapes featuring slots,
   said holes and said slots that might be used in order to increase their drag and added mass enhancing effectiveness.
The areas and the aspect ratios of said devices that enhance the drag and added mass in differing directions need not be the same, in fact in a general case they would be different.
Said aspect ratio is defined herein as the square of its maximum dimension presented to the flow divided by the surface area of a given shape, presented to the flow along the mean normal vector to the surface of the shape.
Said reduction, including said reductions,
   in the dynamic component of said effective tension,
   including and excluding any reduction in said negative component of said dynamic effective tension,
at any locality, including any localities, along said line, including any multitude of lines, by said arrangement favorably combining said relatively low average effective tension, including and excluding said catenary line properties, with a use of said novel devices according to this invention that feature modified technical characteristics involving any combination of said mass, said buoyancy, said approximately neutral buoyancy, said submerged weight, said drag force and said added mass of said novel device.
Said increase in said dynamic minimum in the variation of the line radius of curvature at any locality, including any localities, along said line, including any multitude of lines, being achieved by said arrangement favorably combining said relatively low average effective tension, including and excluding said catenary line properties, with a use of said novel devices according to this invention that feature modified technical characteristics involving any combination of said mass, said buoyancy, said approximately neutral buoyancy, said submerged weight, said drag force and said added mass of said novel device.
Said increase in the fatigue life of any component of said line, including any multitude of lines, including any internal component of said line cross section, at any locality, including any localities, along said line being achieved by said arrangement favorably combining said relatively low average effective tension, including and excluding said catenary line properties, with a use of said novel devices that feature modified technical characteristics involving any combination of said mass, said buoyancy, said approximately neutral buoyancy, said submerged weight, said drag force and said added mass of said novel device.
Said reduction, including said reductions,
   in the dynamic component of said effective tension,
   including and excluding any reduction in said negative component of said dynamic effective tension,
at any locality, including any localities, along said line, including any multitude of lines, by said arrangement favorably combining said relatively low average effective tension, including and excluding said catenary line properties, with a use of any combination of said known devices and said novel devices.
Said increase in said dynamic minimum in the variation of the line radius of curvature at any locality, including any localities, along said line, including any multitude of lines by said arrangement favorably combining said relatively low average effective tension, including and excluding said catenary line properties, with a use of any combination of said known devices and said novel devices.
Said increase in the fatigue life of any component of said line, including any multitude of lines, including any internal component of said line cross section, at any locality, including any localities, along said line, including any multitude of lines, by said arrangement favorably combining said relatively low average effective tension, including and excluding said catenary line properties, with a use of any combination of said known devices and said novel devices.
Dynamics decoupling, damping and added mass enhancing arrangement including a single device and also including a system of multiple devices and also including any plurality of systems of such devices, which affect line dynamic motion in marine engineering; said line including any flexible riser, any umbilical, any cable, any tether, any tendon, any hose, any jumper, any tensioned riser including free standing risers, any hybrid riser tower, any steel catenary riser, any rigid riser made of another material, including titanium and aluminum; said lines utilizing novel devices according to this invention, which feature modified technical characteristics involving any combination of said mass, said buoyancy, said approximately neutral buoyancy, said submerged weight, said drag force and said added mass of said novel device anywhere along said line; said novel devices involving a use of arbitrary geometry shapes designed to increase hydrodynamic drag and added mass of said novel devices, in comparison with those of devices of known design used on said lines; said geometric shapes including any three dimensional arrangements of circles, ellipses, ovals, triangles, squares, rectangles and other arbitrary polygons, arbitrary star figures, helical strakes and any complex combinations of flat and three dimensional figures; any and all of said figures having smooth edges and any and all of said figures having rugged edges; said shapes having solid flat shape areas, solid curved areas, which might incorporate a curvature, and which might feature twisting, and also said shapes featuring holes, said shapes featuring slots, said holes and said slots that might be used in order to modify their drag and added mass modifying effectiveness; the areas and the aspect ratios of said devices that enhance the drag and added mass in differing directions need not be the same, in fact in a general case they would be different.
Dynamic motion suppressing arrangement, as described herein that is used on any new built line of known configuration.
Any multitude of drag and added mass enhancing devices, as described herein, using arbitrary geometrical shapes according to this invention intersect at wide range of angles including acute angles and right angles.
Any multitude of drag and added mass enhancing devices, including continuously distributed said devices, as described herein, installed at any locations on said line.
Dynamic motion suppressing arrangement, as described herein that is retrofitted to suppress motions on any existing, already installed line.
Line configuration involving any multitude of said devices, including continuously distributed said devices, as described herein, installed on said line so that at least a portion of said line having said devices installed thereon stretches on both sides of the design touch down point in any design line configuration.
Dynamic motion suppressing arrangements, as described herein that is used anywhere on said line that involves a suppression of Vortex Induced Vibrations.
The design optimization process, as described herein that is used in the motion suppression optimization design.
Any field development and any field redevelopment project that uses arrangements, devices and design processes as described herein.
Any multitude of added mass and drag enhancing devices, as described herein, using arbitrary geometrical shapes according to this invention intersect at wide range of angles including acute angles and right angles.
Dynamic motion suppressing arrangement, as described herein that is retrofitted to suppress motions on any existing, already installed line.
The design optimization process, as described herein that is used in the motion suppression optimization design.
Any field development and any field redevelopment project that uses arrangements, devices and design processes described herein.

This invention has been described with reference to example embodiments that present in detail the design arrangement invented and means to achieve the novel degree of the dynamic motion suppression of catenary lines used in marine engineering. Multiple variations and modifications exist within the scope and spirit of the invention as described and defined in the following claims.

What is claimed is:

1. An apparatus for increasing the effective mass of a flexible, undersea line comprising:
a generally cylindrical chamber having a central, axial passageway sized to accommodate the line;
at least one opening in the chamber for admitting seawater; and,
means for attaching the chamber to an undersea line.

2. An apparatus as recited in claim 1 wherein the undersea line is selected from the group consisting of risers, umbilicals, cables, tethers, tendons, hoses and jumpers.

3. An apparatus as recited in claim 1 wherein the at least one opening for admitting seawater is a non-valved opening.

4. An apparatus as recited in claim 1 further comprising a plurality of openings for admitting seawater.

5. An apparatus as recited in claim 1 configured such that, when submerged, the chamber is flooded with seawater.

6. An apparatus for increasing the effective mass of a flexible, undersea line comprising:
a plurality of generally planar, intersecting plates symmetrically arranged about a central, axial tube having means for engaging an undersea line.

7. An apparatus as recited in claim 6 wherein the undersea line is selected from the group consisting of risers, umbilicals, cables, tethers, tendons, hoses and jumpers.

8. An apparatus as recited in claim 6 wherein the generally planar, Intersecting plates comprise three, mutually orthogonal circular plates.

9. An apparatus as recited in claim 6 wherein the generally planar, intersecting plates comprise three, mutually orthogonal elliptical plates.

10. An apparatus as recited in claim 6 wherein the generally planar, intersecting plates comprise at least two, mutually orthogonal rectangular plates and at least two elliptical plates parallel to one another and perpendicular to the at least two rectangular plates.

11. An apparatus as recited in claim 6 wherein the generally planar, intersecting plates comprise at least two, mutually orthogonal elliptical plates and at least two elliptical plates that are parallel to one another and perpendicular to the mutually orthogonal elliptical plates.

12. An apparatus as recited in claim 6 wherein the generally planar, intersecting plates comprise at least two, mutually orthogonal star-shaped plates and at least two, star-shaped plates that are parallel to one another and perpendicular to the mutually orthogonal plates.

13. An apparatus as recited in claim 6 wherein the generally planar, intersecting plates comprise at least two rectangular plates that are perpendicular to one another.

14. An apparatus as recited in claim 6 wherein the generally planar, intersecting plates comprise a first and second, mutually orthogonal, elliptical plates of substantially the same size and a third elliptical plate, orthogonal to both the first and second plates and having a major and minor axis that are each larger than the corresponding axes of the first and second plates.

15. An apparatus as recited in claim 6 wherein the generally planar, intersecting plates comprise a first and a second, generally elliptical plates perpendicular to one another and being substantially the same size and a third and fourth generally elliptical plates parallel to one another and each perpendicular to the first and second plates, the major axes of the third and fourth generally elliptical plates being approximately equal to the minor axes of the first and second plates.

16. An apparatus for increasing the effective mass of a flexible, undersea line comprising:
a plurality of generally helical plates symmetrically arranged about a central, axial tube having means for engaging an undersea line;
a first substantially circular end plate attached to and perpendicular to the central, axial tube;
a second, substantially circular end plate parallel to the first end plate and attached to and perpendicular to the central, axial tube.

17. An apparatus as recited in claim 16 wherein the first and second end plates have a jagged circumferential outer edge.

18. An apparatus as recited in claim 16 wherein the helical plates are attached to the first and second end plates.
